(19) United States
(12) Patent Application Publication
(10) Pub. No.: US 2004/0122944 A1
(43) Pub. Date: Jun. 24, 2004

(54) Method and system of locating computers in distributed computer system

(76) Inventors: Didier Poirot, Plaisir (FR); Francois Armand, Noisy-Le-Roi (FR); Jean-Marc Fenart, Montigny le Bretonneux (FR)

Correspondence Address: WAGNER, MURABITO & HAO LLP, Third Floor, Two North Market Street, San Jose, CA, 95113, US

(21) Appl. No.: 10/609,212

(22) Filed: Jun. 27, 2003

(30) Foreign Application Priority Data
Jun. 28, 2002 (FR) 0208078

(51) Int. Cl. G06F 15/173

(52) U.S. Cl. 709/224

(57) ABSTRACT

Locating nodes in a distributed computer system. The system comprises a switch having ports. The switch comprises agent code that is operable to report status of the ports and to identify a node coupled to the ports. The system also has a node coupled to the switch that has manager code. The manager code is operable to retrieve, from the switch, status of a port of the switch. The manager code is also operable to request, from the switch, an identifier of a node coupled to the port of the switch in response to status for the port meeting a condition. The manager code is further operable to maintain a table of data groups comprising port identifiers and identifiers of nodes coupled to the ports.

### RELATED APPLICATION

This application claims priority to French Patent Application Number 0208078, filed on Jun. 28, 2002, in the name of SUN Microsystems, Inc., which application is hereby incorporated by reference.

### BACKGROUND OF THE INVENTION

1. Field of the Invention

The present invention relates to the field of distributed computer systems. Specifically, embodiments of the present invention relate to distributed computer systems comprising computers or other hardware entities called nodes.

2. Background Art

Some distributed computer systems comprise connection entities such as switches to establish connection between nodes. In distributed computer systems, especially in distributed computer systems required to be highly available, it is highly important to improve communications between nodes. Thus, some nodes are required to exchange a great number of messages. For these nodes, it is of particular interest to reduce network distances between them and to gather these nodes in connecting them on the same connection entity or on neighbor connection entity. These requirements involve locating nodes.

### SUMMARY OF THE INVENTION

The present invention provides a method and system of managing a distributed computer system. In one embodiment, a method comprises managing a distributed computer system comprising a plurality of nodes coupled to a switch. One of the nodes receives status of a port of the switch. Responsive to the status meeting a condition, the node receives a node identifier from the switch for a node coupled to the port. The node maintains a table of data groups comprising port identifiers and node identifiers of nodes coupled to ports of the switch.

Another embodiment in accordance with the present invention is a distributed computer system. The system comprises a switch having ports and comprises agent code that is operable to report status of the ports and to identify a node coupled to the ports. The system has at least one node coupled to the switch that comprises manager code. The manager code is operable to retrieve, from the switch, status of a port of the switch. The manager code is also operable to request, from the switch, an identifier of a node coupled to the port of the switch in response to status for the port meeting a condition. The manager code is further operable to maintain a table of data groups comprising port identifiers and identifiers of nodes coupled to the ports.

Embodiments of the present invention provide these advantages and others not specifically mentioned above but described in the sections to follow.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a general diagram of a node in a distributed computer system.

FIG. 2 is a general diagram of a distributed computer system comprising nodes connected via switches.

FIG. 3 is an illustration of an exemplary node Ni, in which embodiments in accordance with the invention may be applied.

FIG. 4 is a functional diagram of a switch using an information management protocol on network, e.g., SNMP.

FIG. 5 is a table of data groups comprising identifiers of switch ports linked to identifiers of nodes according to an embodiment of the invention.

FIG. 6 is a flowchart illustrating a method to build a table of data groups comprising identifiers of switch ports linked to identifiers of nodes according to an embodiment of the invention.

FIG. 7 is a flowchart illustrating a method to update a table of data groups comprising-identifiers of switch ports linked to identifiers of nodes according to an embodiment of the invention.

### DETAILED DESCRIPTION OF THE INVENTION

In the following detailed description of the present invention, location of computers in a distributed computer system, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

This invention also encompasses embodiments implemented with software code, especially when made available on any appropriate computer-readable medium. The expression “computer-readable medium” includes a storage medium such as magnetic or optic, as well as a transmission medium such as a digital or analog signal.

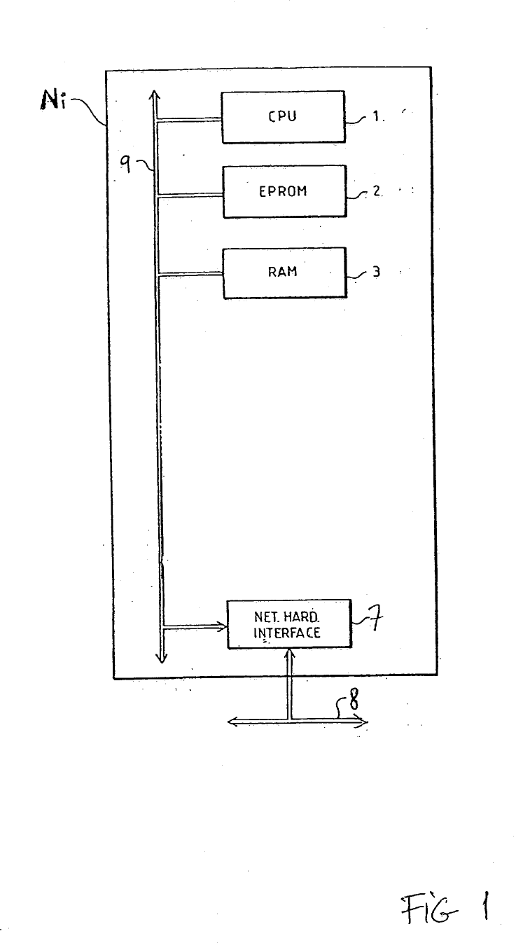

Embodiments of the present invention may be implemented in a network comprising computer systems. The hardware of such computer systems is for example as shown in FIG. 1, where in the computer system Ni:

1 is a processor, e.g., an Ultra-Sparc (SPARC is a Trademark of SPARC International Inc.);

2 is a program memory, e.g., an EPROM for BIOS;

3 is a working memory for software, data and the like, e.g., a RAM of any suitable technology (SDRAM for example); and

7 is a network interface device connected to a communication medium 8, itself in communication with a switch to enable communication with other computers. Network interface device 7 may be an Ethernet device, a serial line device, or an ATM device, inter alia. Communication medium 8 may be based on wire cables, fiber optics, or radio-communications, for example.

The computer system, also called node Ni, may be a node amongst a group of nodes in a distributed computer system. Some nodes may further comprise a mass memory, e.g., one or more hard disks.

Data may be exchanged between the components of FIG. 1 through a bus system 9, schematically shown as a single bus for simplification of the drawing. As is known, bus systems may often include a processor bus, e.g., of the PCI type, connected via appropriate bridges to e.g., an ISA bus and/or an SCSI bus.

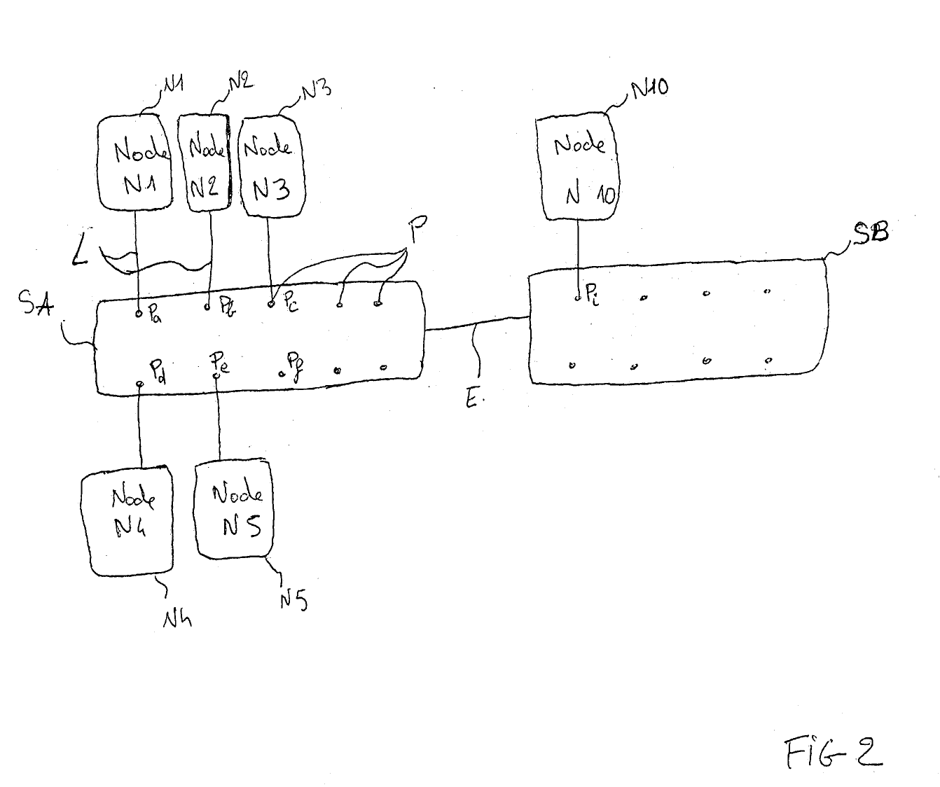

FIG. 2 shows an example of a group of nodes arranged as a cluster. The cluster has several nodes N1, N2, N3, N4, N5, . . . N10.

References to the drawings in the following description will use two different indexes or suffixes i and j, each of which may take anyone of the values: {1, 2, 3 . . . , n} n being the number of nodes in the cluster. In the foregoing description, a switch is only an example of a connection entity for nodes on the network.

In FIG. 2, each node Ni is connected to a network, e.g., the Ethernet network, which may be also the Internet network. The node Ni is connected to a switch SA, e.g., an Ethernet switch, capable of interconnecting the node Ni with other nodes Nj. The switch comprises several ports P, each being capable of connecting a node Ni to the switch SA via a link L. In an embodiment of a switch, the number of ports per switch is limited, e.g., to 24 ports in some switch technologies. Several switches may be linked together in order to increase the number of nodes connected to the network, e.g., the Ethernet network. Thus, in FIG. 2, a switch SB is connected to the switch SA via a link E, e.g., an Ethernet link. By way of example only, the switch may be called an Ethernet switch if the physical network is an Ethernet network. Indeed, different switch types exist such as Ethernet switch and Internet switch also called IP switch. Each switch has an identifier:

for an Ethernet switch, the identifier is e.g., a MAC address being an Ethernet address or an IP address for administration,

for an IP switch, the identifier is e.g., an IP address.

Each switch port has an identifier, e.g., a port number being generally an integer or an Ethernet port address.

In the following description, an Ethernet switch is used but the invention is not restricted to this switch type.

If desired, for availability reasons, the network also may be redundant. Thus, the links L may be redundant: nodes Ni of the cluster are connected to a second network via links L′ (not depicted in FIG. 2) using a redundant switch as a switch SA′ (not depicted in FIG. 2). This redundant network is adapted to interconnect a node Ni with another node Nj through the links L′. For example, if node Ni sends a packet to node Nj, the packet may be therefore duplicated to be sent on both networks. Although this redundancy may not be described herein in detail, the second network for a node may be used in parallel with the first network or replace it in case of first network failure.

Also, as an example, it is assumed that packets are generally built throughout the network in accordance with a transport protocol and a presentation protocol, e.g., the Ethernet Protocol and the Internet Protocol. Corresponding IP addresses are converted into Ethernet addresses on Ethernet network.

A node is connected to other nodes or a group of nodes (cluster) using a connection entity as the switch. When an administrator connects a node to the group of nodes, the administrator connects the node to the network, but the administrator does not know to which switch and to which port the node is connected. Thus, once connected to a port of a switch, the location of the node on the network is not known. Embodiments in accordance with the invention provide improvements in this matter.

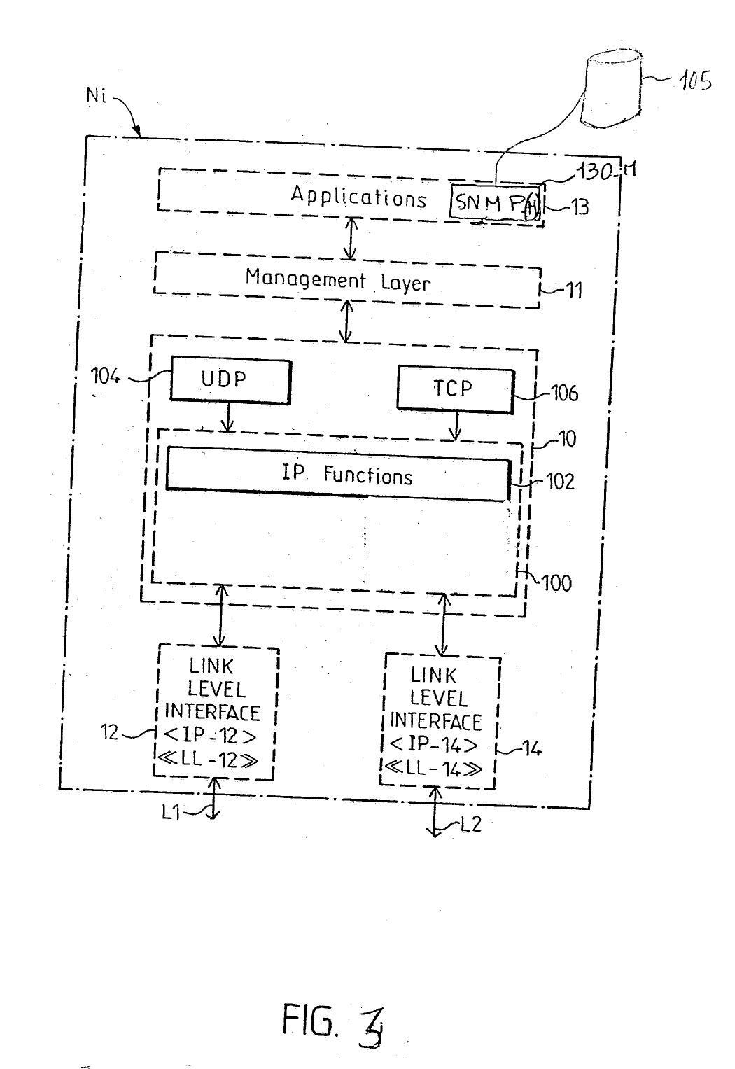

FIG. 3 shows an exemplary node Ni, in which the embodiments in accordance with the invention may be applied. Node Ni comprises, from top to bottom, applications 13, management layer 11, network protocol stack 10, and Link level interface 12, which is connected to the first network with link L1. Optionally Link level interface 14, in case of network redundancy, is connected to second network with link L2. Applications 13 and management layer 11 can be implemented, for example, in software executed by the node's CPU. Network protocol stack 10 and link level interfaces 12 and 14 can likewise be implemented in software and/or in dedicated hardware such as the node's network hardware interface 7 of FIG. 1. Node Ni may be part of a local or global network. In the foregoing exemplary description, the network is an Ethernet network, by way of example only. It is assumed that each node may be uniquely defined by a portion of its Ethernet address. Accordingly, as used hereinafter, “IP address” means an address uniquely designating a node in the network being considered (e.g., a cluster), whichever network protocol is being used. Although Ethernet is presently convenient, no restriction to Ethernet is intended.

Thus, in the example, network protocol stack 10 comprises:

an IP interface 100, having conventional Internet protocol (IP) functions 102,

above IP interface 100, message protocol processing functions, such as UDP function 104 and TCP function 106.

Network protocol stack 10 is interconnected with the physical networks through first Link level interface 12 (and second Link level interface 14 if network redundancy is desired). These are in turn connected to first and second network channels, via couplings L1 and L2 and via first and second switches.

Link level interface 12 has an Internet address <IP-12> and a link level address [symbol] LL-12 [symbol] . Incidentally, the doubled triangular brackets ( [symbol] . . . [symbol] ) are used only to distinguish link level addresses from global network addresses. Similarly, Link level interface 14 has an Internet address <IP-14> and a link level address [symbol] LL-14 [symbol] . In an embodiment in which the physical network is Ethernet-based, interfaces 12 and 14 are Ethernet interfaces, and [symbol] LL-12 [symbol] and [symbol] LL-14 [symbol] are Ethernet addresses.

IP functions 102 comprise encapsulating a message coming from upper layers 104 or 106 into a suitable IP packet format, and, conversely, de-encapsulating a received packet before delivering the message it contains to upper layer 104 or 106.

An interface may be adapted in the IP interface 100 to manage redundancy of packets from the link level interfaces 12 and 14.

References to Ethernet are exemplary and other physical networks may be used, implying Link level interfaces 12 and 14 based on other networks. Moreover, other protocols than TCP or UDP may be used as well in stack 10.

The node comprises in its application layer 13 a manager module 130-M adapted to:

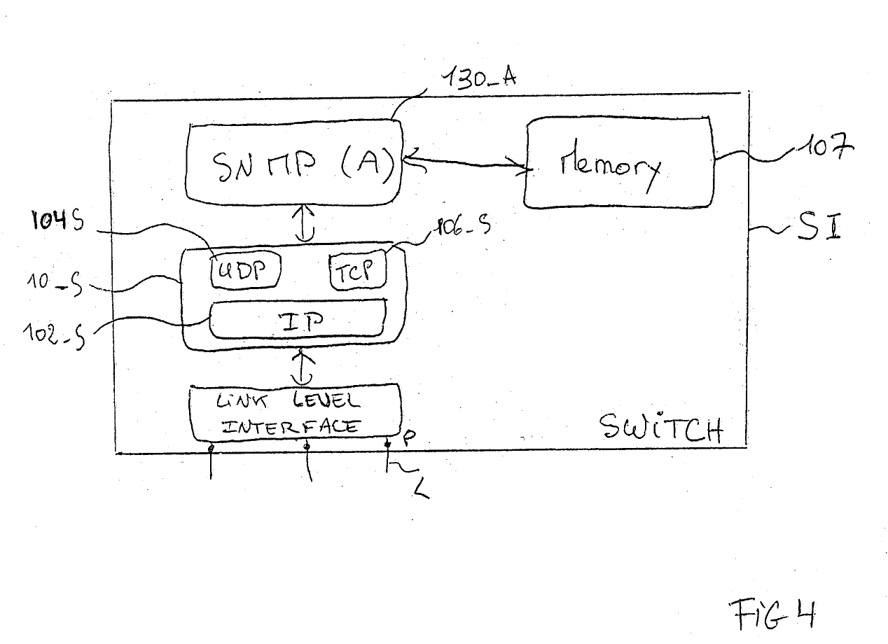

use a network information management protocol, e.g., the simple network management protocol (SNMP) as described in RFC 1157 (May 1990), in order to work in relation with an agent module, specifically an agent module in a connection entity, e.g., a switch, using advantageously the same network information management protocol as described in FIGS. 4,

request an agent module to perform network management functions defined by the SNMP protocol, such as a get-request(var) function requesting the agent module to return the value of the requested variable var, a get-next-request(var) function requesting the agent module to return the next value associated with a variable, e.g., a table that contains a list of elements, the set-request(var, val) function requesting the agent module to set the value val of the requested variable var.

Exemplary SNMP messages from the manager module include:

get-request(var, [, var, . . . J)

get-next-request(var, [, var, . . . J)

set-request(var, val, [, var, val . . . J)

The manager module 130-M is linked to a memory 105 in order to store data, e.g., the information retrieved from an agent module. The SNMP protocol used in the manager module 130-M may be based on the UDP/IP transport protocol or other transport protocols such as TCP/IP.

FIG. 4 shows a switch Si adapted to connect nodes between them and also to be connected to other switches. The switch of FIG. 4, being e.g., an Ethernet switch, comprises an agent module 130-A. This agent module is adapted to:

use a network information management protocol, e.g., the simple network management protocol (SNMP),

perform network management functions requested by nodes having a manager module 130-M and

transmit results of requests with the get-response(var) function or transmit exceptional events to the manager module 130-M with the trap(code) function.

Exemplary SNMP messages from the agent include:

get-response(var, [, var, . . . J) trap(code)

The simple network management protocol (SNMP) is a management protocol at an application level as described in the RFC 1157 (May 1990). It is based on a network protocol stack 10-S comprising IP stack 102-S and message protocol processing functions, e.g., an UDP function 104-S and/or a TCP function 106-S. The SNMP protocol used in the agent module 130-A may be based on the UDP/IP transport protocol or other transport protocols such as TCP/IP.

The manager module and the agent module may also be designated as a manager code and an agent code.

The SNMP protocol enables an agent module to implement several Management Information Bases (MIB) used by the manager module. An MIB interface concerns configuration information for devices, e.g., the definition of paper sheet dimensions for printing devices, a MIB switch concerns information on the connections between the ports of the switch and the nodes. The Management Information Bases implemented are for example: an MIB switch, as the known Bridge-MIB, providing the agent module information about the switch such as the port numbers and the node identifiers and providing to the manager module information to request the agent module, an MIB interface as the known RFC1213-MIB or IF-MIB providing the agent module the port status and providing to the manager module information to request the agent module. Other MIB may be implemented in the agent module and used by manager modules. In the switch, the agent module 130-A implements these MIB and stores the information of these implemented MIB in a memory 107.

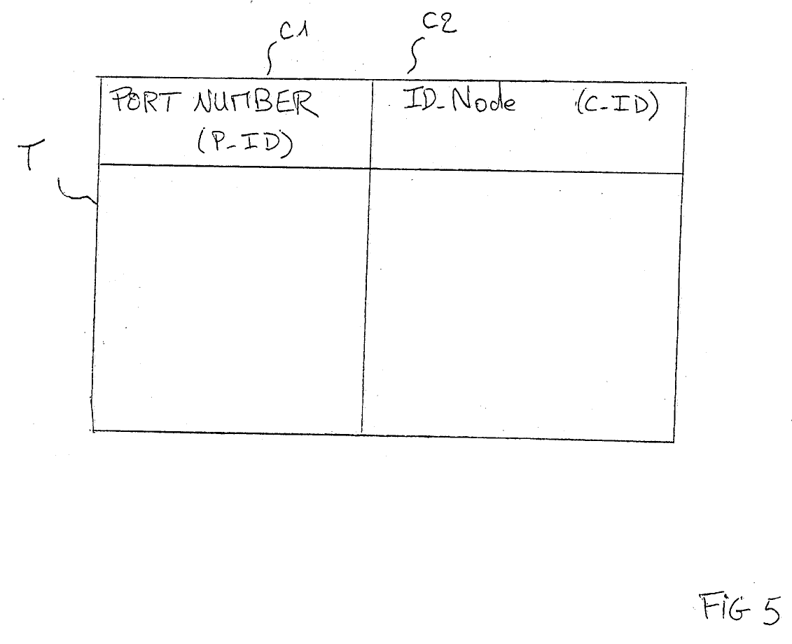

In an embodiment of the invention, the manager module 130-M is thus arranged to retrieve node location information from requests to the agent module 130-A, to store these information in a memory in a form of a table (T) as described in FIG. 5, thus providing a node location in the group of nodes and to update the table on change indication from the agent module.

The manager module 130-M sends a request for a connection with the agent module 130-A of a switch, this request identifying the switch, e.g., providing the IP address of the switch. This request is also a request for a session to be opened, e.g., an SNMP-session identifying the switch. Different connections from a manager module 130-M may be requested in parallel. Once the connection is established between the manager module 130-M and the agent module 130-A, the manager module sends a get-request( ) function to the agent module of the switch in the cluster. In the node having the manager module, a user or a program (probe) defines the variable requested in this get-request( ) function. This variable may be the port number. An agent module retrieves the port number in its memory 107 of FIG. 4 and sends it to the manager module. A user or a program (probe) in the manager module may also request for the status of the port having this port number. The port is identified with its port number indicated in the get-request ( ) function as an input variable. An agent module retrieves the status of a port in its memory 107 of FIG. 4, the port status of the switch being stored in the memory 107 when implemented with an MIB interface. The variable port status is indicated in a return get-response ( ) function and may have a value of down or up. The port status down indicates that no node has sent a signal or message to this port, so there may be no node connected to the port or the connected node may not be alive (dead). The port status up indicates that a node has sent a signal or message to this port, so a node is connected to the port. The port status up in the get-response ( ) function may be completed with a value learned indicating that the port is connected to a node whose identifier is in the memory 107 of the switch, accessible for the agent module.

In this last case, the manager module requests the agent module for the identifier of the node connected to the port having the learned value. The manager module requests for this identifier using another get-request ( ) function specifying the variable node identifier connected to the port having the given port number. If the agent module retrieves the node identifier of this node and sends it back to the manager module in the variable node identifier using get-response ( ) function, the manager module can retrieve the data couple “port number/node identifier.” The manager module stores this data couple in a list which may be a table T in memory.

In another embodiment, a table of port numbers in the agent module may also have been requested by the manager module. For example, the manager module may issue the SNMP message “snmp_get_port_table (struct snmp_session*ss)” identifying the SNMP_session. A table of port status in the agent module may have been requested by the manager module. For example, the manager module may issue the SNMP message “snmp_get oper_status (struct snmp_session*ss)”, identifying the snmp_session. A table of node identifiers in the agent module may have been requested by the manager module. For example, the manager module may issue the SNMP message “snmp_get_fdb_table (struct snmp_session*ss)”, identifying the SNMP _session. In this case, the manager module has retrieved all the information from the agent module, may then process each port number, port status and node identifier to establish the table T.

In an embodiment of the invention and by way of example of FIG. 5, the exemplary table (T) comprises a first column C1 defining the port identifier (P-ID) being e.g., the port number and a second column C2 defining the identifier of the node (C-ID) connected to this port, the identifier of the node being e.g., the Ethernet address for an Ethernet switch and an IP address for an IP switch. In an embodiment, the table only indicates the ports being connected to an identified node.

The table is advantageously updated on agent module's message called trap(code) indicating an exceptional event such as:

the port status has changed to down,

the port status has changed to up.

The trap(code) provides the Internet switch address and the port identifier (e.g., port number) for which the status has changed. The manager may request more information on the basis of the trap ( ) agent module's messages.

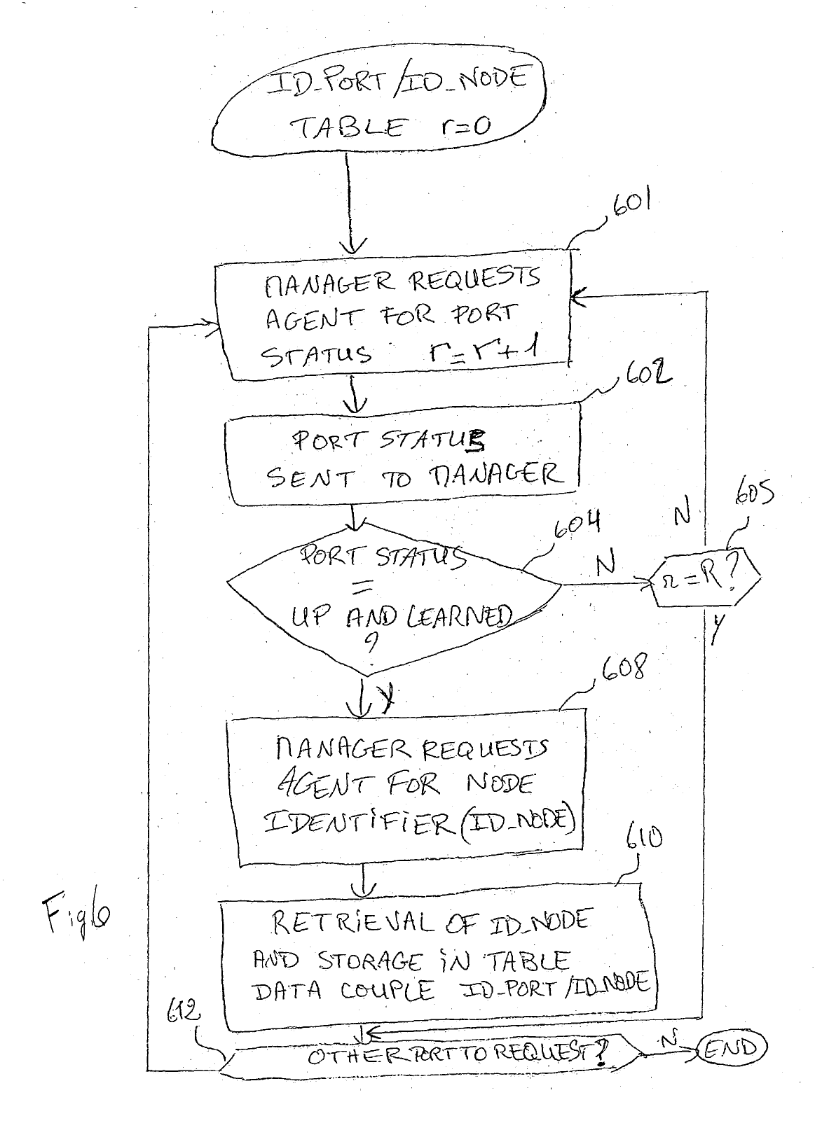

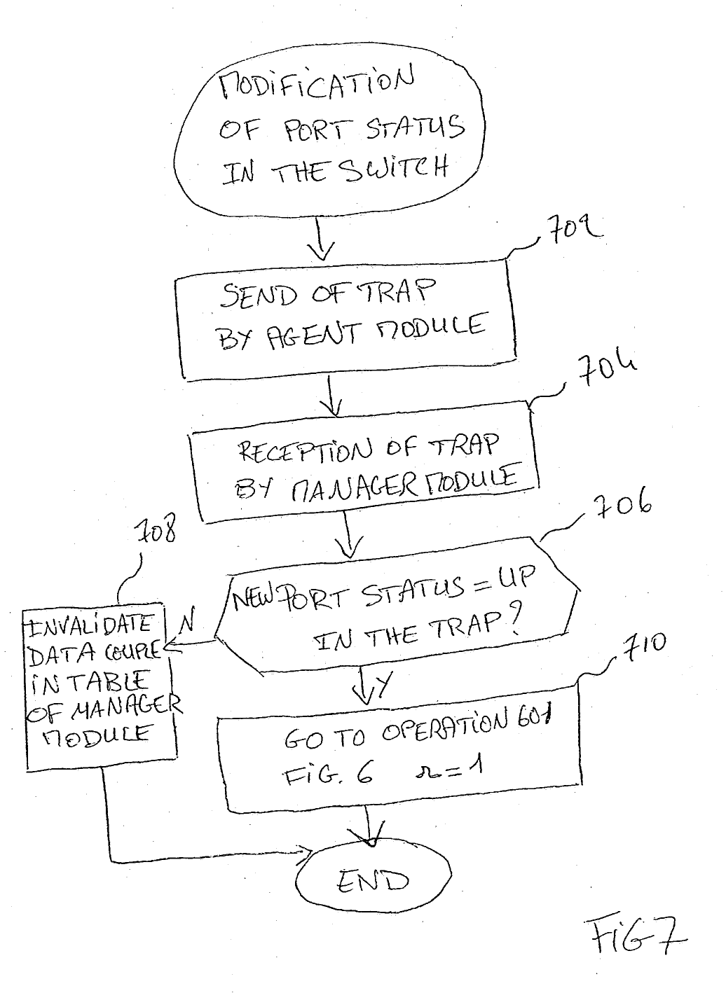

FIG. 6 illustrates a method to build a table, such as the exemplary table (T), according to an embodiment of the invention based on manager module requests. FIG. 7 illustrates a complementary method to update data couples of the exemplary table (T) of FIG. 5.

In FIG. 6, the process is aimed to build a table of at least data couples indicating port identifier/node identifier. In operation 601, the manager module requests an agent module of a switch designated with its identifier (e.g., IP address of the switch or the name of the switch) for the status of a given port designated with its port identifier (e.g., its port number or its MAC address). At operation 602, the agent module having retrieved this port status, e.g., in a database of the memory 107, sends the port status and other additional information to the manager module of the requesting node.

If the port status indicates that a node is connected to this port and that its node identifier is known at operation 604 (“learned”), the manager module may request the agent module to determine the identifier of the connected node at operation 608. The agent module may retrieve this information in a Management Information Base implemented in the agent module as hereinbefore described and send it to the manager module. At operation 610, the manager module retrieves the node identifier corresponding to the port number and stores the data couple in a table, this data couple indicating at least the node identifier and the port identifier. At operation 610, a data couple corresponding to the same port identifier may be already stored in the table. In this case, the retrieved node identifier (new node identifier) and the node identifier already stored in the table (old node identifier) are compared and responsive to a difference between them, the old node identifier is replaced by the new node identifier. The data couple in the table is thus updated. If other ports are requested by the manager module at operation 612, the process returns to operation 601, else it ends.

If the port status indicates that the port is down, or if the port status indicates that a node is connected to this port and without indicating that the node identifier is known (or indicating that the node identifier is not known) at operation 604, the manager module may restart operations 601 to 604 for this port. The manager module restarts operations 601 to 604 for this port until the port status is up at operation 604 or until at operation 605 the manager module has restarted R consecutive times operations 601 to 604 for this port, R being an integer greater than 1. In this last case, the process continues at operation 612.

The process of FIG. 6 may be repeated regularly to request for node identifier connected to a port identifier in order to update the table and to maintain a current table.

A manager module may execute the flowchart of FIG. 6 in parallel for different ports in an agent module or in several agent modules.

In FIG. 7, a modification of the status of a port may appear in the switch. For example, a node having a down status may change to an up status and vice/versa. FIG. 7 illustrates an embodiment for handling such a case. In this case, an agent module sends a trap ( ) function, as described hereinbefore, in operation 702. The manager module receives this trap at operation 704. If the port status indicates the value up, at operation 710 the flow-chart continues in FIG. 6 operation 601. For an already stored data couple in the manager module's memory, the manager module retrieves the node identifier for the port and updates the already stored data couple in operation 610 of FIG. 6. If the port status indicates the value down at operation 706, the data couple in the manager module's memory is invalidated at operation 708. After operations 708 or 710, the flowchart ends.

The invention is not limited to the hereinabove embodiments. Thus, the table of the manager module's memory may comprise other columns or information concerning, for example, the time at which the information for the port and the connected node is retrieved. The manager module may regularly request information such as the port status and the node identifier connected to this port. The manager module may define a period of time to retrieve the information. In an embodiment, the table may also indicate all the ports and their status. If the node has a down status or if it is not identified, the column C2 is empty. This enables the manager module, the node having the manager module, or a user requesting this node, to have a sort of map for ports of a switch and to know to which port the node is connected.

If the port of a node is down, this port status is indicated in the table and the node connected to this port may be changed and may be connected to another port having an up status.

The invention covers a software product comprising the code used in the invention, specifically in the manager module.

The invention also covers a software product comprising the code for use in the method of managing a node location.

The preferred embodiment of the present invention a method and system of location of computers in distributed computer system, is thus described. While the present invention has been described in particular embodiments, it should be appreciated that the present invention should not be construed as limited by such embodiments, but rather construed according to the below claims.

What is claimed, is:

1. A method of managing a distributed computer system comprising a plurality of nodes coupled to a switch, said method comprising:
a) receiving status of a port of said switch;
b) responsive to said status meeting a condition, receiving a node identifier from said switch for a node coupled to said port; and
c) maintaining a table of data groups comprising port identifiers and node identifiers of nodes coupled to ports of said switch.

2. The method of claim 1, wherein said a) comprises requesting agent code of said switch for port status.

3. The method of claim 2, wherein said b) comprises, responsive to said status meeting a condition, requesting said agent code for identifiers of nodes connected to said port.

4. The method of claim 1, wherein said b) comprises, responsive to said status meeting a condition, requesting agent code of said switch for identifiers of nodes connected to said port.

5. The method of claim 1, wherein the status of a port of said a) indicates that the port is up or down.

6. The method of claim 1, wherein the status of a port of said a) indicates, when the port is up, that the node identifier is known or unknown.

7. The method of claim 1, wherein the condition of said b) comprises that the port status is up and indicates that the node identifier is known.

8. The method of claim 1, wherein:
said a) comprises receiving a message from the switch indicating a new port status; and
said b) comprises:
if the port status is down, invalidating a data group in the table having the same port identifier;
else, responsive to said status meeting the given condition, requesting agent code of the switch for the identifier of the node connected to said port.

9. The method of claim 1, wherein said c) comprises comparing the node identifier received in said b) with the node identifier in the table for said port and responsive to a difference between the received node identifier and the node identifier in the table, updating the node identifier associated with the port identifier in the table for the said port.

10. The method of claim 1, wherein the port identifier is a port number.

11. The method of claim 1, wherein the data groups in the table comprise the time of the storage of the port and the node identifiers.

12. The method of claim 1, wherein said a) to said c) are repeated regularly to request a node identifier connected to a port identifier and to update the table.

13. A distributed computer system comprising:
a switch having ports and comprising agent code operable to report status of said ports and to identify a node coupled to ones of said ports; and
a node coupled to said switch and comprising manager code operable to:
retrieve, from said switch, status of a port of said switch;
request, from said switch, an identifier of a node coupled to said port of said switch in response to status for said port meeting a condition; and
maintain a table of data groups comprising port identifiers and identifiers of nodes coupled to said ports.

14. The distributed computer system of claim 13, wherein the manager code is further operable to request the agent code for status of said ports and, responsive to said status meeting a given condition, request the agent code for identifiers of the nodes connected to said ports.

15. The distributed computer system of claim 13, wherein the status of a port indicates that the port is up or down.

16. The distributed computer system of claim 13, wherein the status of a port indicates, when the port is up, that the node identifier is known or unknown.

17. The distributed computer system of claim 13, wherein the condition comprises that the port status is up and indicates that the node identifier is known.

18. The distributed computer system of claim 13, wherein the agent code is further operable to send a message indicating a new port status and, the manager code is further operable to:
i) if the new port status is down, invalidate a data group in the table having the same port identifier,
ii) else, responsive to said new port status meeting the condition, request the agent code for the identifier of the node connected to said port.

19. The distributed computer system of claim 13, wherein the manager code is further operable to:
compare a received node identifier for a port with a node identifier in the table for said port; and
responsive to a difference between the received node identifier and the node identifier in the table, update the node identifier associated with the port identifier in the table for said port.

20. The distributed computer system of claim 13, wherein the port identifier is a port number.

21. The distributed computer system of claim 13, wherein the data groups in the table comprise the time for the storage of the port and the node identifiers.

22. The distributed computer system of claim 13, wherein the manager code is further operable to repeatedly request the node identifier of a port identifier.

23. A computer readable medium having stored therein instructions which when executed on a processor implement a method of managing a distributed computer system comprising a plurality of nodes coupled to a switch, said method comprising:
a) receiving status of a port of said switch;
b) responsive to said status meeting a condition, receiving a node identifier from said switch for a node coupled to said port; and
c) maintaining a table of data groups comprising port identifiers and node identifiers of nodes coupled to ports of said switch.

24. The computer readable medium of claim 23, wherein said a) of said method comprises requesting agent code of said switch for port status.

25. The computer readable medium of claim 23, wherein said) of said method comprises, responsive to said status meeting a condition, requesting said agent code for identifiers of nodes connected to said port.

26. The computer readable medium of claim 23, wherein said b) of said method comprises, responsive to said status meeting a condition, requesting agent code of said switch for identifiers of nodes connected to said port.

27. The computer readable medium of claim 23, wherein the status of a port of said a) of said method indicates that the port is up or down.

28. The computer readable medium of claim 23, wherein the status of a port of said a) of said method indicates, when the port is up, that the node identifier is known or unknown.

29. The computer readable medium of claim 23, wherein the condition of said b) of said method comprises that the port status is up and indicates that the node identifier is known.

30. The computer readable medium of claim 23, wherein:
the status said a) of said method comprises receiving a message from the switch indicating a new port status; and
said b) of said method comprises:
if the port status is down, invalidating a data group in the table having the same port identifier;
else, responsive to said status meeting the given condition, requesting agent code of the switch for the identifier of the node connected to said port.

31. The computer readable medium of claim 23, wherein:
said c) of said method comprises comparing the node identifier received in said b) of said method with the node identifier in the table for said port and responsive to a difference between the received node identifier and the node identifier in the table, updating the node identifier associated with the port identifier in the table for the said port.

32. The computer readable medium of claim 23, wherein the port identifier is a port number.

33. The computer readable medium of claim 23, wherein the data groups in the table comprise the time of the storage of the port and the node identifiers.

34. The computer readable medium of claim 23, wherein said a) of said method to said c) of said method are repeated regularly to request a node identifier connected to a port identifier and to update the table.
